(19) United States
(12) Patent Application Publication
(10) Pub. No.: US 2006/0275571 A1
(43) Pub. Date: Dec. 7, 2006

(54) Polyethylene pipes

(76) Inventors: Cliff Robert Mure, Hillsborough, NJ (US); Han-Tai Liu, Hillsborough, NJ (US)

Correspondence Address: Univation Technologies, LLC, Suite 1950, 5555 San Felipe, Houston, TX, 77056, US

(21) Appl. No.: 11/143,039

(22) Filed: Jun. 2, 2005

(51) Int. Cl. B32B 1/08

(52) U.S. Cl. 428/36.9

(57) ABSTRACT

A pipe composition comprising, in one embodiment, from 80 to 99 wt % of a high density polyethylene by weight of the composition and from 1 to 20 wt % of a filler by weight of the composition; the polyethylene having a density of from 0.940 to 0.980 g/cm³, and an 121 of from 2 to 18 dg/min; characterized in that the pipe composition extrudes at an advantageously low melt temperature and at an advantageously high specific throughput. Also provided is a method of forming a pipe comprising in embodiment providing a filler composition comprising from 5 to 50 wt % of a filler and from 95 to 50 wt % of a low density polyethylene and from 0 to 3 wt % of one or more stabilizers; then melt blending the filler composition and a high density polyethylene having a density of from 0.940 to 0.980 g/cm³, and an I₂₁ of from 2 to 18 dg/min to a target drop temperature of from 16° C. to 185° C. to form a pipe composition, melt blending such that the pipe composition comprises from 1 to 20 wt % of the filler by weight of the pipe composition; and extruding the pipe composition to form a pipe.

### FIELD OF THE INVENTION

The present invention relates to polyethylene pipes, and more particularly, to polyethylene compositions suitable for making high strength pipes with improved extrudability, and methods of making such pipes.

### BACKGROUND OF THE INVENTION

Pipes made from high density polyethylenes are well known in the art. The pipes are formed by melt extruding the polyethylene blended with a filler material such as carbon black, the pipes thus formed in the melt stage at a desired inner and outer diameter and wall thickness as determined by the die that is used to form the pipe. One problem with such a procedure is that the pipe, before cooling, can sag and thus produce poor pipes. This problem can be partially ameliorated by lowering the temperature of the extruder, and thus lowering the temperature of the extrudate. However, this can cause poor output, or specific throughput, of the extrudate and thus increase the cost of producing the pipe. Further, increasing the output while lowering the temperature of the extruder can undesirably increase the back pressure in the extruder. This problem has yet to be addressed for polyethylene resins used to produce pipes.

While high density polyethylenes have recently been described in U.S. Pat. No. 6,878,454 that can be advantageously extruded to produce films having low gel counts, this does not solve the problem of extruding compositions suitable for pipes, which include a relatively large amount of filler material that influence the composition properties, as well as having other distinct properties such as the need for high rapid crack propagation strength.

What is needed is a high density polyethylene that, when combined with the desired amount of filler, can be extruded at a desirably low melt temperature to prevent sagging but can, at the same time, be extruded at a sufficiently high throughput. The inventors have solved this problem with an improved high density polyethylene having an improved balance of properties.

### SUMMARY OF THE INVENTION

One aspect of the present invention is to a pipe composition comprising, in one embodiment, from 80 to 99 wt % of a high density polyethylene by weight of the composition and from 1 to 20 wt % of a filler by weight of the composition; the polyethylene having a density of from 0.940 to 0.980 g/cm³, and an I₂₁ of from 2 to 18 dg/min; characterized in that the pipe composition extrudes at a melt temperature, Tₘ, that satisfies the following relationship:
Tₘ≦230−3.3(I₂₁)
wherein the composition also extrudes at a specific throughput of from greater than 1.38 kg/hr/rpm to form the pipe.

In another aspect, the present invention provides, in one embodiment, a method of forming a pipe comprising:

(a) providing a filler composition comprising from 5 to 50 wt % of a filler and from 95 to 50 wt % of a low density polyethylene and from 0 to 3 wt % of one or more stabilizers;

(b) melt blending the filler composition and a high density polyethylene having a density of from 0.940 to 0.980 g/cm³, and an I₂₁ of from 2 to 18 dg/min to a target drop temperature of from 165° C. to 185° C. to form a pipe composition, melt blending such that the pipe composition comprises from 1 to 20 wt % of the filler by weight of the pipe composition; and

(c) extruding the pipe composition to form the pipe.

These aspects may be combined with various embodiments disclosed herein to describe the invention(s).

### DETAILED DESCRIPTION OF THE INVENTION

A preferred embodiment of the invention is described herein, directed to a pipe composition having improved properties when extruded into a pipe. By “pipe”, what is meant is a conduit for such substances as, but not limited to, liquids, gases and flowable solids, such as particulates, such conduit having any suitable dimensions and shape to carry out such purpose, and further, such conduit may consist essentially of the pipe composition of the invention, or merely comprise such pipe composition as by one or more layers or portions thereof.

In one embodiment, the pipe composition comprises from 80 to 99 wt % of a high density polyethylene by weight of the composition and from 1 to 20 wt % of a filler by weight of the composition; the polyethylene having a density of from 0.940 to 0.980 g/cm³, and an I₂₁ of from 2 to 18 dg/min (I ₂₁, ASTM-D-1238-F, 190° C./21.6 kg). The pipe composition is characterized in its capability for high throughput at low melt temperatures during extrusion of the composition to form a pipe. The pipe is thus characterized in that the pipe composition extrudes at a melt temperature, Tₘ, that satisfies the following relationship (1):

Tₘ≦230−3.3(I₂₁) (1)

wherein the composition also extrudes at a specific throughput of from greater than 1.38 kg/hr/rpm to form the pipe under the following conditions of extrusion: using a 60 mm screw having 30:1 L/D ratio in a grooved feed extruder, wherein the “melt temperature” is the temperature of the pipe composition melt at the downstream end of the mixing zone of the extruder used in extruding the pipe composition, that temperature measured either by immersion probe (“probe”) or infra red probe (“IR”). The equation above is satisfied by use of an immersion probe,or if by infra red probe, by use of the equation Tₘ≦228−3.3(I₂₁). Other set conditions for satisfaction of equation (1) are as follows in Table 1.

TABLE 1
Test Extrusion Conditions for Equation (1)
and specific throughput relationship

| Zone Temps, ° C. | |
|---|---|
| grooved feed zone | — |
| Zone 1 | 204 |
| Zone 2 | 204 |
| Zone 3 | 204 |
| Zone 4 | 204 |
| Die 1 | 204 |
| Die 2 | 204 |
| Die 3 | 204 |
| Die 4 | 204 |
| Die 5 | 204 |
| Die 6 | 204 |
| Die 7 | 204 |
| Die 8 | 221 |
| Die 9 | 221 |
| Screw RPM | 230-240 |
| Puller Speed (ft/min) | 5-6 |
| Pipe thickness, avg. (mm) | 10-11 |

The “zone” temperatures in Table 1 are nominal temperatures, that is, they may vary by ±3 degrees as would be understood by those skilled in the art. The die is preferably annular and is sized such that the pipe extruded therefrom has a thickness as indicated.

In a more preferred embodiment, the specific throughput ranges from greater than 1.40 kg/hr/rpm, and most preferably greater than 1.42 kg/hr/rpm; and in another embodiment the specific throughput ranges from 1.38 to 20 kg/hr/rpm, and more preferably from 1.38 to 10 kg/hr/rpm, and more preferably from 1.40 to 10 kg/hr/rpm, and even more preferably from 1.42 to 8 kg/hr/rpm, wherein a desirable specific throughput range can comprise any single lower limit described herein, or any combination of any lower limit with any upper limit described herein.

In another embodiment, equation (1) is represented by Tₘ≦235−3.3(I₂₁), and in yet another embodiment, equation (1) is represented by Tₘ≦230−3.2(I₂₁), and in yet another embodiment, equation (1) is represented by Tₘ23 230−3.4(I₂₁), and in yet another embodiment, equation (1) is represented by Tₘ≦235−3.2(I₂₁), and in yet another embodiment, equation (1) is represented by Tₘ≦235−3.4(I₂₁).

The conditions described in Table 1 reflect a characterizing feature of the pipe compositions herein and are not meant to be limiting of the invention as by a method step per se, as the pipe compositions described herein are useful for forming any type of pipe under any number of extrusion conditions and using any suitable extruder for forming pipes as is known in the art. Any size extruder suitable for forming extruding the pipe composition for forming a pipe can be used, in one embodiment a smooth bore or grooved feed extruder is used, and either twin- or single-screw extruders are suitable, a length:diameter (L/D) ratio ranging from 1:20 to 1:100 in one embodiment, preferably ranging from 1:25 to 1:40, and the diameter of the extruder screw having any desirable size, ranging for example from 30 mm to 500 mm, preferably from 50 mm to 100 mm. Extruders suitable for extruding the pipe compositions described herein are described further in, for example, SCREW EXTRUSION, SCIENCE AND TECHNOLOGY (James L. White and Helmut Potente, eds., Hanser, 2003).

In one embodiment, the pipe composition is extruded through an annular pipe die having a diameter of from 5 to 500 mm to form the pipe, and from 6 to 400 mm in another embodiment, and from 8 to 200 mm in yet another embodiment, and from 9 to 100 mm in yet another embodiment. In another embodiment, the composition is extruded such that the pipe has a wall thickness ranging from 3 to 30 mm, more preferably ranging from 4 to 20 mm, and even more preferably ranging from 5 to 18 mm, and most preferably ranging from 7 to 15 mm.

The “filler” can be any suitable filler known to those in the art including but not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, acetylene black, dolomite, calcium carbonate, talc and hydrotalcite compounds of the ions Mg, Ca, or Zn with Al, Cr or Fe and CO₃ and/or HPO₄, hydrated or not; quartz powder, hydrochloric magnesium carbonate, glass fibers, clays, alumina, and other metal oxides and carbonates, metal hydroxides, chrome, phosphorous and brominated flame retardants, antimony trioxide, silicone, and blends thereof. Fillers in general, and carbon blacks in particular, are described in RUBBER TECHNOLOGY, 59-104 (Chapman & Hall 1995). The pipe composition comprises from 1 to 10 wt % of the filler by weight of the pipe composition in a more preferable embodiment, and from 1.5 to 8 wt % of the filler in a more preferable embodiment, and from 1.5 to 6 wt % of the filler in a most preferable embodiment, wherein a desirable range may comprise any combination of any upper limit with any lower limit described herein. In a preferred embodiment, the filler is one or more types of carbon black.

Another aspect of the invention is directed to a method of forming a pipe comprising providing a filler composition comprising from 5 to 50 wt % of a filler and from 95 to 50 wt % of a low density polyethylene and from 0 to 3 wt % of one or more stabilizers; then melt blending the filler composition and a high density polyethylene having a density of from 0.940 to 0.980 g/cm³, and an I₂₁ of from 2 to 18 dg/min to a target drop temperature of from 165° C. to 185° C. to form a pipe composition, melt blending such that the pipe composition comprises from 1 to 20 wt % of the filler by weight of the pipe composition; and then extruding the pipe composition to form a pipe. More preferably, the filler composition comprises from 10 to 40 wt % filler by weight of the filler composition, and most preferably from 20 to 40 wt % filler by weight of the filler composition, wherein the linear low density polyethylene is proportioned with respect to the filler and stabilizer (if present). The low density polyethylene may be any suitable polyethylene known in the art having a density in the range of from 0.87 to 0.93 g/cm³ in a preferred embodiment. Most preferably, the low density polyethylene that is part of the filler composition is a linear low density polyethylene.

The “target drop temperature” is achieved by melt blending the components to form the filler composition by such means as is commonly known in the art. Batch or screw-type blenders such as a Brabender or Kobe can be used. Most preferably, the target drop temperature is a temperature ranging from 167 to 182° C., and even more preferably is a temperature ranging from 170 to 180° C.

“Stabilizers” include such substances known in the art including but not limited to the class of compounds such as organic phosphites, hindered amines, and phenolic antioxidants. These stabilizers may be added to the pipe compositions by any means, but preferably are added as part of the filler composition. Such stabilizers may be present in the filler compositions, if at all, from 0.001 to 3 wt % in one embodiment, and more preferably from 0.01 to 2.5 wt %, and most preferably from 0.05 to 1.5 wt %. Non-limiting examples of organic phosphites that are suitable are tris(2,4-di-tert-butylphenyl)phosphite (IRGAFOS 168) and di(2,4-di-tert-butylphenyl)pentaerithritol diphosphite (ULTRANOX 626). Non-limiting examples of hindered amines include poly[2-N,N′-di(2,2,6,6-tetramethyl-4-piperidinyl)-hexanediamine-4-(1 -amino- 1,1,3,3-tetramethylbutane)symtriazine] (CHIMASORB 944); bis(1,2,2,6,6-pentamethyl-4-piperidyl)sebacate (TINUVIN 770). Non-limiting examples of phenolic antioxidants include pentaerythrityl tetrakis(3,5-di-tert-butyl-4-hydroxyphenyl) propionate (IRGANOX 1010); 1,3,5-Tri(3,5-di-tert-butyl-4-hydroxybenzyl-isocyanurate (IRGANOX 3114); tris(nonylphenyl)phosphite (TNPP); and Octadecyl-3,5-Di-(tert)-butyl-4-hydroxyhydrocinnamate (IRGANOX 1076); other additives include those such as zinc stearate and zinc oleate.

The pipes thus formed and described herein are suitable for such applications as carrying fluids, under pressure in one embodiment, and can be buried under ground by any suitable means for carrying such fluids. To carry out such purpose, the pipes described herein may possess a resistance to rapid crack propagation (RCP) characterized by a critical pressure of greater than 10 bars tested by the S-4 test (ISO 13477) at 0° C. Furthermore, the pipes formed herein have a “PE-80” grade or more, preferably a “PE-100” grade or more, as is known in the art for polyethylene pipes and described in, for example, PE100 Resins for Pipe Applications: Continuing the Development into the 21^{st} Century, in 4(12) TRENDS IN POLYMER SCIENCE 408-415 (1996)

The polyethylene useful in the pipe compositions are preferably “high density polyethylenes”, meaning they have a density (Sample preparation method ASTM D4703-03; density test method, gradient column per ASTM D1505-03) of from 0.940 to 0.980 g/cm³, more preferably from 0.942 to 0.975 g/cm³, and even more preferably from 0.943 to 0.970 g/cm³, and even more preferably from 0.944 to 0.965 g/cm³, and most preferably from 0.945 to 0.960 g/cm³, wherein a desirable density may comprise any combination of any upper limit with any lower limit as described herein.

The high density polyethylene may be unimodal, multimodal or bimodal, and is preferably multimodal or bimodal, and most preferably is bimodal. In a preferred embodiment, the bimodal high density polyethylene comprises at least one high molecular weight component (HMW) and at least one low molecular weight component (LMW). The term “bimodal,” when used to describe the polyethylene composition, means “bimodal molecular weight distribution,” which term is understood as having the broadest definition persons in the pertinent art have given that term as reflected in printed publications and issued patents. For example, a single polyethylene that includes polyolefins with at least one identifiable high molecular weight distribution and polyolefins with at least one identifiable low molecular weight distribution is considered to be a “bimodal” polyolefin, as that term is used herein. Those high and low molecular weight polymers may be identified by deconvolution techniques known in the art to discern the two polymers from a broad or shouldered GPC curve of the high density polyethylenes of the invention, and in another embodiment, the GPC curve of the polyethylenes may display distinct peaks with a trough. The polyethylene compositions of the invention may be described by a combination of other features.

The high density polyethylenes useful herein are preferably copolymers, and more preferably, copolymers of ethylene and C₃ to C₁₀ α-olefin derived units, most preferably copolymers of 1-hexene or 1-butene derived units. The high density polyethylenes preferably comprise from 1 to 10 wt % comonomer derived units by weight of the copolymer, and even more preferably comprise from 1.5 to 6 wt % comonomer derived units. The LMW component preferably comprises from 0.1 to 2 wt % comonomer derived units by weight of the LMW component, and even more preferably, from 0.2 to 1.5 wt %. The HMW component preferably comprises from 0.5 to 8 wt % comonomer derived units by weight of the HMW component, and even more preferably from 0.6 to 4 wt % comonomer derived units.

Preferably, the amount or “split” of the HMW component ranges from greater than 50 wt % relative to the entire composition, and ranges between 55 and 75 wt % in another embodiment.

In one embodiment, the high density polyethylene comprises at least one HMW component, the HMW component having a short chain branching index ranging from 1.8 to 10. The “branching index” is the amount of alkyl branching per 1000 carbon atoms of the main polymer chains, and can be determined by size exclusion chromatograph (SEC) of the high density polyethylene, the fractions then collected at different molecular weights, and their respective ¹H NMR spectra obtained. From these spectra, the amount of branching can be determined. In more preferable embodiment, the short chain branching index ranges from 2 to 5.

Preferably, the high density polyethylene comprises one HMW component having a weight average molecular weight ranging from greater than 60,000 Daltons, and more preferably greater than 70,000 Daltons, and even more preferably greater than 80,000 Daltons, and in less than 1,000,000 Daltons in a preferred embodiment, and less than 800,000 Daltons in a more preferred embodiment. Also, the high density polyethylene preferably comprises one LMW component having a weight average molecular weight ranging from less than 60,000 Daltons, and more preferably from less than 50,000 Daltons, and even more preferably between 5,000 and 40,000 Daltons. These values can be determined by techniques known in the art, such as by gel permeation chromatography, wherein the individual components can be discerned and deconvoluted, such as described in more detail herein.

In a preferred embodiment, the high density polyethylene has a molecular weight distribution (a weight average molecular weight to number average molecular weight, M_{w}/Mₙ) ranging from 20 to 200, and more preferably from 30 to 100, and even more preferably from 35 to 80, wherein a desirable range may comprise any upper limit with any lower limit described herein. The molecular weight distribution can be determined by techniques known in the art such as by gel permeation chromatography (GPC). For example, MWD can be determined by gel permeation chromatography using crosslinked polystyrene columns; pore size sequence: 1 column less than 1000 Å, 3 columns of mixed 5×10(7) Å; 1,2,4-trichlorobenzene solvent at 145° C. with refractive index detection. The GPC data can be deconvoluted into high and low molecular weight components by use of a “Wesslau model”, wherein the β term can be restrained for the low molecular weight peak to a certain value, preferably 1.4, as described by E. Broyer & R. F. Abbott, Analysis of molecular weight distribution using multicomponent models, ACS SYMP. SER. (1982), 197 (COMPUT. APIP. APIP. POLYM. Sci.), 45-64.

In a preferred embodiment, the I₂₁ of the high density polyethylene ranges from 2 to 16 dg/min, and more preferably from 3 to 14 dg/min, and even more preferably from 4 to 12 dg/min, and most preferably from 5 to 10 dg/min, wherein a desirable range may comprise any upper limit with any lower limit described herein. Also, in another preferred embodiment, the high density polyethylene possesses an I₂₁I₂ value (I₂, 2.16 kg, 190° C.) ranging from 60 to 200, and more preferably ranging from 80 to 180, and even more preferably from 100 to 180.

The high density polyethylene can be produced by any suitable means such as by a slurry, solution, high pressure or gas phase process, and in one embodiment, is produced by a combination of any two or more (the same or different) of these or other processes known in the art, such as is know to produce certain polyethylenes in a “staged” process. In a preferred embodiment, the high density polyethylene is produced in a single reactor, and most preferably, in a single continuous gas phase fluidized bed reactor. Such reactors are well known in the art and described in more detail in U.S. Pat. Nos. 5,352,749, 5,462,999 and WO 03/044061.

It is well known to use catalysts to produce polyolefins, and in particular, polyethylenes. The high density polyethylenes described herein can be produced by combining one or more catalysts and optionally an activator, preferably a bimetallic catalyst composition, with ethylene and one or more α-olefins, C₃ to C₁₀ α-olefins in one embodiment, preferably 1-butene or 1-hexene, in the reactor and isolating the high density polyethylene.

In one embodiment, the bimetallic catalyst composition comprises at least one metallocene compound and at least one Group 3 to Group 10 coordination compound such as described in, for example, U.S. Pat. No. 6,274,684 and U.S. Pat. No. 6,656,868. More preferably, suitable coordination complexes are either two, three or four-coordinate and include those where the coordinating atoms include oxygen, nitrogen, phosphorous, sulfur, or a combination thereof, and the coordinated atom includes one of titanium, zirconium, hafnium, iron, nickel or palladium. Most preferably, the metallocene and coordination compounds are supported with an activator on a support material and injected into the reactor(s), preferably as a hydrocarbon slurry, with an optional third catalyst component co-injected to adjust the properties of the high density polyethylene resulting therefrom. Preferably, the high density polyethylene is produced using such a catalyst composition in a single gas phase reactor.

Thus, the compositions and processes of the present invention can be described alternately by any of the embodiments disclosed herein, or a combination of any of the embodiments described herein. Embodiments of the invention, while not meant to be limiting by, may be better understood by reference to the following examples.

### EXAMPLES

Catalyst Composition and Polymerization to form Inventive High Density Polyethylene

The high density polyethylene examples used in the inventive examples were produced by combining ethylene and 1-hexene comonomer in a single gas phase reactor at from 75 to 95° C. with a catalyst composition comprising spray dried composition of (pentamethylcyclopentadienyl)(propylcyclopentadienyl) zirconium difluoride, {[(2,3,4,5,6-Me₅C₆H₂)NCH₂CH₂]₂NH}Zr(CH₂Ph)₂ and methalumoxane with a silica (Ineos ES757) support. The molar ratio of Zr from the amide-coordination compound to Zr from the metallocene ranges from 2.7 to 3.5. Additional (pentamethylcyclopentadienyl)(propylcyclopentadienyl) zirconium difluoride was added to the reactor separately to adjust the relative amounts of the LMW component, thus the “split” between the LMW and HMW components. The split was controlled such that there was about 55 wt % of the HMW relative to the entire composition, based on GPC analysis.

The single gas phase fluidized bed reactor used had a diameter of 8 feet and a bed height (from distributor “bottom” plate to start of expanded section) of 38 feet. During each run, the reacting bed of growing polyethylene particles was maintained in a fluidized state by a continuous flow of the make-up feed and recycle gas through the reaction zone. As indicated in the tables, each polymerization run for the inventive examples utilized a target reactor temperature (“Bed Temperature”), namely, a reactor temperature of about 75-95° C. During each run, reactor temperature was maintained at an approximately constant level by adjusting up or down the temperature of the recycle gas to accommodate any changes in the rate of heat generation due to the polymerization. The fluidized bed of the reactor was made up of polyethylene granules. During each run, the gaseous feed streams of ethylene and hydrogen were introduced before the reactor bed into a recycle gas line. The injections were downstream of the recycle line heat exchanger and compressor. Liquid comonomer was introduced before the reactor bed. The individual flows of ethylene, hydrogen and comonomer were controlled to maintain target reactor conditions, as identified in each example. The concentrations of gases were measured by an on-line chromatograph.

The properties of the resultant high density polyethylenes are as described in the Tables 2 and 3.

Carbon Black Compounding Conditions:

Trial 1. These samples were compounded and pelletized on a Banbury F270 batch mixer equipped with a 15 inch single screw extruder and underwater pelletizing system. Mixer rotors (ST type) were run at 83.5 rpm. Mixing time of the Inventive and Comparative samples with a masterbatch of carbon black was set to achieve a target drop temperature of 170° C. The resins were stabilized with Irganox 1010 and Irgafos 168. Carbon black was added through a masterbatch. The masterbatch containing 40% carbon black and a LLDPE was added at 5.6 wt % resulting in 2.25 wt % carbon black in the formulation.

Trial 2. These samples were compounded and pelletized on a counter-rotating twin-screw Kobe LCM-100 equipped with a melt pump and underwater pelletizing system. Production rate on the compounding line is 550 lb/hr. The resin was stabilized with Irganox 1010 and Irgafos 168. Carbon black was added through a masterbatch in a similar manner to that in Trial 1. The masterbatch composition was carbon black, 35 wt %, Irganox 1010, 0.2 wt %, and LLDPE, 64.8 wt %, each weight percent is by weight of the whole masterbatch composition. The masterbatch containing 35% carbon black was added at 6.5 wt % resulting in 2.25 wt % carbon black in the formulation.

Pipe Extrusion Conditions:

Trial 1. The pipe extrusion trial was run on a Cincinnati Milacron grooved barrel extruder, model CMS-90-28-GP. The screw was a 90 mm barrier type screw. The extrusion head was a Battenfeld basket-type head. Pipe was made to ISO specifications for 315 mm SDR 11. Other details are in Table 3.

Trial 2. The pipe extrusion trial was run on an American Maplan grooved barrel extruder, model SS-60-30. The screw was a 60 mm barrier type screw with 30:1 L/D ratio. The extrusion head was a basket-type head. Pipe was made to ASTM specifications for 4 inch SDR 11. Other details are in Table 2.

Description of Resins Tested:

Trial 1. The Inventive formulation has a natural density of 0.948 g/cm³ (black density 0.958 g/cm³) and high load melt index I₂₁ of 6.3. The comparative samples were commercially available bimodal pipe resins having a density of about 0.945-0.950 g/cm³ and an I₂₁ of from about 6 to 10 g/dm. Columns 2 and 4, corresponding to nominally the same rpm conditions for the commercial Comparative and Inventive Example, should be compared. The specific output for Inventive Example in column 4 is 8.3% higher than that for the Comparative. The melt temperature is lower for the Inventive Example sample.

Trial 2. The Inventive black formulation has a natural density of 0.948 g/cm³ (black density 0.958 g/cm³) and high load melt index I₂₁ of 6.3. DGDB-2480 is a unimodal ASTM 3408 or PE-80 type resin with density of 0.944 and I₂₁ of 8. DGDA-2490 is a bimodal resin with density of 0.949 and I₂₁ of 9. The data in columns 1-3 are shown for each sample run at the same nominal screw rpm. The Inventive sample is shown to exhibit specific output (lb/hr/rpm) increase of 4.2% and 6.2% relative to DGDB-2480 and DGDA-2490, respectively. Melt temperatures for all three resins at this operating condition are comparable.

TABLE 2
Trial 1 Samples

| | | | | | |
|---|---|---|---|---|---|
| Sample No. | | 1 | 2 | 3 | 4 |
| Resin | | Comparative, | Comparative, | Inventive | Inventive |
| | | bimodal | bimodal | | |
| Density (natural), g/cm³ | | | | 0.948 | 0.948 |
| I₂₁ (natural), dg/min | | | | 6.3 | 6.3 |
| Zone Temps (° C.) | | | | | |
| Feed Zone | 20 | 42 | 42 | 43 | 43 |
| Zone 1 | 185 | 209 | 213 | 190 | 203 |
| Zone 2 | 185 | 199 | 199 | 187 | 199 |
| Zone 3 | 185 | 189 | 189 | 189 | 189 |
| Zone 4 | 185 | 208 | 211 | 193 | 212 |
| Adapter | 185 | 188 | 192 | 185 | 192 |
| Die 1 | 185 | 187 | 185 | 187 | 184 |
| Die 2 | 185 | 187 | 188 | 188 | 188 |
| Die 3 | 185 | 197 | 200 | 190 | 191 |
| Die 4 | 185 | 185 | 185 | 184 | 185 |
| Die 5 | — | — | — | — | — |
| Die 6 | — | 191 | 192 | 184 | 187 |
| Die 7 | — | 30 | 39 | 46 | 45 |
| Die 8 | — | 192 | 196 | 195 | 195 |
| Melt (probe) (° C.) | | 226 | 211 | 188 | 193 |
| Screw RPM | | 121.2 | 120.4 | 95.8 | 120.2 |
| Motor Amps | | 253 | 292 | 284 | 289 |
| Puller Speed (m/min) | | 0.362 | 0.380 | 0.343 | 0.425 |
| Torque, % | | 77.4 | 77.4 | 77.3 | 77.4 |
| Rate, kg/hr | | 566.0 | 594.6 | 518.9 | 642.9 |
| specific output kg/hr/rpm | | 4.67 | 4.94 | 5.42 | 5.35 |
| Pipe wt setting, kg/m | | 26.050 | 25.940 | 25.132 | 25.387 |

TABLE 3
Trial 2 Samples

| | | | | |
|---|---|---|---|---|
| Sample No. | | 1 | 2 | 3 |
| Resin | | DGDB-2480 | DGDA-2490 | Inventive |
| | | Comparative, | Comparative, | Example |
| | | Unimodal | bimodal | |
| Density (natural), | | 0.944 | 0.949 | 0.948 |
| g/cm³ | | | | |
| I₂₁ (natural), dg/min | | 8 | 9 | 6.3 |
| Zone Temps ° C. | | | | |
| grooved feed zone | | 231 | 231 | 229 |
| Zone 1 | 204 | 205 | 204 | 204 |
| Zone 2 | 204 | 204 | 204 | 204 |
| Zone 3 | 204 | 204 | 204 | 204 |
| Zone 4 | 204 | 204 | 204 | 204 |
| Die 1 | 204 | 204 | 204 | 204 |
| Die 2 | 204 | 204 | 204 | 204 |
| Die 3 | 204 | 204 | 204 | 204 |
| Die 4 | 204 | 204 | 204 | 204 |
| Die 5 | 204 | 204 | 204 | 204 |
| Die 6 | 204 | 204 | 204 | 204 |
| Die 7 | 204 | 204 | 204 | 204 |
| Die 8 | 221 | 221 | 221 | 221 |
| Die 9 | 221 | 221 | 220 | 218 |
| Melt (probe), ° C. | | 208 | 207 | 208 |
| Melt (IR), ° C. | | 206 | 205 | 206 |
| Head Press. | | 1960 | 1900 | 2400 |
| Screw RPM | | 234 | 235 | 234 |
| Motor Amps (%) | | 64 | 60 | 63 |
| Puller Speed | | 5.3 | 5.0 | 5.3 |
| (ft/min) | | | | |
| Rate (lbs/hr) | | 705 | 695 | 735 |
| specific output | | 1.37 | 1.34 | 1.42 |
| (kg/hr/rpm) | | | | |
| Thickness, min, | | 10.5 | 10.4 | 10.6 |
| (mm) | | | | |
| Thickness, max, | | 10.9 | 10.7 | 11.0 |
| (mm) | | | | |

Trial 2 was carried out under the inventive characterizing conditions as in the claims of the invention. The extrusions in Trial 1 show the utility of the invention and its applicability to other extrusion conditions: the specific throughput and melt temperature at the same nominal screw speed were improved for the Inventive Example in Trial 1 compared to the pipe composition comprising the commercial bimodal polyethylene.

We claim:

1. A pipe composition comprising from 80 to 99 wt % of a high density polyethylene by weight of the composition and from 1 to 20 wt % of a filler by weight of the composition; the polyethylene having a density of from 0.940 to 0.980 g/cm³, and an I₂₁ of from 2 to 18 dg/min; characterized in that the pipe composition extrudes at a melt temperature, Tₘ, that satisfies the following relationship:
Tₘ≦230−3.3(I₂₁)
wherein the composition also extrudes at a specific throughput of from greater than 1.38 kg/hr/rpm to form the pipe.

2. The pipe of claim 1, having a resistance to rapid crack propagation (RCP) characterized by a critical pressure of greater than 10 bars tested by the S-4 test (ISO 13477) at 0° C.

3. The pipe of claim 1, wherein the polyethylene comprises at least one high molecular weight component, the high molecular weight component having a short chain branching index ranging from 1.8 to 10.

4. The pipe of claim 2, wherein there is one high molecular weight component having a weight average molecular weight ranging from greater than 60,000 Daltons.

5. The pipe of claim 1, wherein the density of the polyethylene ranges from 0.943 to 0.970 g/cm³.

6. The pipe of claim 1, wherein the I₂₁ of the polyethylene ranges from 4 to 16 dg/min.

7. The pipe of claim 1, wherein the polyethylene has a molecular weight distribution ranging from 20 to 200.

8. The pipe of claim 1, wherein the composition is extruded through a pipe die having a diameter of from 10 to 500 mm to form the pipe.

9. The pipe of claim 1, wherein the specific throughput ranges from 1.38 to 5 kg/hr/rpm.

10. The pipe of claim 1, wherein the pipe has a wall thickness ranging from 5 to 30 mm.

11. The pipe of claim 1, wherein the filler is carbon black.

12. The pipe of claim 1, wherein the polyethylene is produced in a single reactor.

13. The pipe of claim 12, wherein the reactor is a gas phase reactor.

14. The pipe of claim 12, comprising combining a bimetallic catalyst composition with ethylene and one or more α-olefins in the reactor and isolating the polyethylene.

15. The pipe of claim 14, wherein the bimetallic catalyst composition comprises at least one metallocene compound and at least one Group 3 to Group 10 coordination compound.

16. A method of forming a pipe comprising:
(a) providing a filler composition comprising from 5 to 50 wt % of a filler and from 95 to 50 wt % of a low density polyethylene and from 0 to 3 wt % of one or more stabilizers;
(b) melt blending the filler composition and a high density polyethylene having a density of from 0.940 to 0.980 g/cm³, and an I₂₁ of from 2 to 18 dg/min to a target drop temperature of from 165° C. to 185° C. to form a pipe composition, melt blending such that the pipe composition comprises from 1 to 20 wt % of the filler by weight of the pipe composition; and
(c) extruding the pipe composition to form the pipe.

17. The method of claim 16, wherein the pipe composition extrudes at a melt temperature, Tₘ, that satisfies the following relationship:
Tₘ≦230−3.3(I₂₁)
wherein the composition also extrudes at a specific throughput of from greater than 1.38 kg/hr/rpm to form the pipe.

18. The method of claim 16, wherein the filler composition comprises from 10 to 40 wt % filler by weight of the filler composition.

19. The method of claim 16. wherein the pipe composition comprises from 1.5 to 10 wt % of the filler by weight of the pipe composition.

20. The method of claim 16, wherein the polyethylene comprises at least one high molecular weight component, the high molecular weight component having a short chain branching index ranging from 1.8 to 10.

21. The method of claim 20, wherein there is one high molecular weight component having a weight average molecular weight ranging from greater than 60,000 Daltons.

22. The method of claim 16, wherein the density of the polyethylene ranges from 0.943 to 0.970 g/cm³.

23. The method of claim 16, wherein the I₂₁ of the polyethylene ranges from 4 to 10 dg/min.

24. The method of claim 16, wherein the polyethylene has a molecular weight distribution ranging from 30 to 100.

25. The method of claim 16, wherein the filler is carbon black.
